(19) United States
(12) Patent Application Publication
(10) Pub. No.: US 2016/0000648 A1
(43) Pub. Date: Jan. 7, 2016

(54) THIN VIAL PHARMACY BOTTLE SYSTEM

(71) Applicant: Brad Meley, Austin, TX (US)

(72) Inventor: Brad Meley, Austin, TX (US)

(21) Appl. No.: 14/323,456

(22) Filed: Jul. 3, 2014

(51) Int. Cl. A61J 1/03

(52) U.S. Cl. CPC A61J 1/03

(57) ABSTRACT

The invention provides an improved bottle design for pharmacies and patients taking medications. The bottle system is comprised of a container including a generally planar front portion having a generally rectangular shape and a generally planar back portion space from the front portion. The back portion has a generally rectangular shape and generally faces away in an opposite direction from the front portion. The container also comprises a pair of side portions opposite to and spaced form each other, with each side portion extending between the front portion of the container and the back portion of the container. Each side portion comprises of a generally trapezoidal shape. The front portion and the back portion are configured for adhesive placement of a medication-related label on the front portion and the back portion of the container.

### CROSS-REFERENCE TO RELATED APPLICATIONS

USPTO PATENT APPLICATION No. 61/957,181

FILING DATE Jun. 27, 2013

CONFIRMATION NUMBER 7914

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISK APPENDIX

NOT APPLICABLE

### BACKGROUND OF THE INVENTION

Nearly everyone consumes prescription pharmaceuticals at one point in their lives. With a large amount of data being printed on the prescription bottle label, it has become increasing more difficult for the consumer of the prescription or the care taker of the patient to not only be aware of but also remember the various warning instructions, patient directives as to when to take the medicine, patient directives as to what to take (or not take) the medicine with, and other cautionary instructions specific to the medicine.

With many patients now taking more than one prescription at any given period, patients can easily confuse what directions and warnings correspond with each medicine bottle. Highlighting these warning instructions at the time the bottle is opened is necessary and critical to the wellness of the patient.

Older adults have more difficulty opening child resistant prescription pill bottles due to age related conditions such as Parkinson's Disease, joint pain, limited hand strength, a reduction in their motor skills, and reduced/impaired vision. Conventional pharmacy bottles, therefore, can be difficult to open as adults get older and their medical condition changes. Coupled with the potential for a hand or arm injury, opening a pill bottle can become a major inconvenience to a patient taking prescription medicine.

Given the importance of ensuring the accuracy of labeling prescription pill bottles, the potential confusion amongst patients as to when and what their medicine should be taken with or without, no general uniformity in label design, and the difficulty for patients with arthritis and limited strength to open conventional pill bottles, the current confusion and challenges to open and close traditional pill bottles is neither acceptable nor safe.

Individuals taking prescription medicine from a pill bottle have difficulty in taking the medicine as prescribed. Such a challenge stems from the poor labeling systems which currently attached to a round, cylindrical object known as a pill bottle. The round, cylindrical design is neither logical nor practical in allowing the intended patient to clearly and accurately read warning labels and potential side-effect disclosures from their medicine. Furthermore, the round, cylindrical nature of the current pill bottle forces the intended recipient of the medicine to have to twist and turn the bottle a number of times to read the most simplest of messages. The current poor design of prescription pill bottles is not safe, easy to read nor is it easy to open.

The design of a round, cylindrical prescription pill bottle provided very limited leverage for the person opening the bottle. With no protruding points to grab, the individual opening the prescription pill bottle can get frustrated with the process of opening a poorly designed bottle.

### SUMMARY OF THE INVENTION

Embodiments of the invention are directed to a pharmacy bottle system. In one embodiment, a prescription pharmacy bottle comprises a container including a generally planar front portion having a generally rectangular shape and a generally planar back portion space from the front portion. The back portion has a generally rectangular shape and generally faces away in an opposite direction from the front portion. The container also comprises a pair of side portions opposite to and spaced from each other, with each side portion extending between the front portion of the container and the back portion of the container. Each side portion comprises of a generally trapezoidal shape. The front portion and the back portion are configured for adhesive placement of a medication-related label on the front portion and the back portion of the container.

### RELATED

The present invention generally relates to medication dispensing, and particularly relates to a pill dispending assembly for dispensing pills.

Prescription drugs are being prescribed and taken in an increasing rate of use. With many patients taking multiple drugs throughout the day and/or week, their ability to take each unique pill as directed by their physician has become increasingly more challenging.

Although pharmacies can track how often prescriptions are filled, and can control an amount of pills given to a patient with dosing, they cannot ensure that the patient doesn't disregard a dosing schedule and ingest an excess quantity of pills at a given time. Pharmacies also cannot ensure that patients, caretakers or other people with access to patient medication do not misinterpret pill bottle label directions. Particularly in cases where patients have a known history of taking pills that require specific directions about the frequency of usage, time of day when to take the pill, avoidance directives (i.e. ‘do not drive or operate heavy machinery under the influence of this medication’), and therefore it is desirable to prevent those patients from engaging in the improper consumption of the drug. To date, pharmacies have relied on warning labels that are often limited in more effectively highlighting their importance of the warning. Secondly, such warning labels, due to the current design of pill bottles—wrap around a cylindrical pill bottle and create a vision challenge to effectively read such a warning. Such labeling systems do not effectively address any of the issues discussed above to prevent improper drug consumption, improper guidance on warnings from the pharmacy and/or drug company and improper highlights of potential side effects.

### BRIEF DESCRIPTION OF THE DRAWINGS

Embodiments of the invention will be described with respect to the figures, in which like reference numerals denote like elements, and in which:

FIG. 1 is a sectional view of a pharmacy bottle system, according to an embodiment of the invention.

FIG. 2 is a plan view of a pharmacy bottle system, according to an embodiment of the invention.

FIG. 3 is a plan view of a pharmacy bottle system, according to an embodiment of the invention.

FIG. 4 is a sectional view of a pharmacy bottle system, according to an embodiment of the invention.

FIG. 5 is a schematic illustration, including a plan view of a pharmacy bottle system, according to an embodiment of the invention.

FIG. 6 is a schematic illustration, including a view of the threading which connects the cap to the bottle system.

### DETAILED DESCRIPTION

In the following detailed description, reference is made to the accompanying drawings, which form a part hereof, and in which is shown by way of illustration specific embodiments in which the invention may be practiced. In this regard, directional terminology, such as “top”, “bottom”, “front”, “back”, “leading”, “trailing” is used with reference to the orientation of the Figure(s) described.

Because components of the embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of the invention are directed to a pharmacy bottle system and label system that significantly enhances a consumer's experience in filling a prescription at a retail pharmacy. In one embodiment, a pharmacy bottle system is comprised of a container, including a label and/or set of labels, and a cap. The bottle container is sized and shaped to hold a medication from a prescription that can be in the form of a pill, gel tablet, powder, liquid or other forms of medication. The bottle container is unique in design by having the removable cap in the center of the container, with large and relatively flat surfaces along side the cap. The embodiment of the cap at the top and center of the bottle system creates leverage from the individual opening the container. This embodiment allows one hand to grasp the bottle system in a natural manner while the other hand simply opens the cap as it is designed to be opened. For individuals with limited hand strength or mobility, the embodiment of placing the cap at the center of the bottle device allows one to place the bottle system on a surface, hold in place with one hand and open the cap as it is designed to be opened.

In another embodiment, next to the cap are large and relatively flat surfaces designed to provide space for warning labels, directives from the pharmacy and/or drug manufacturer to highlight specific instructions as to whom should be taking the medicine (known commonly as ‘the patient’), the frequency of the medication in which it should be taken, common side effects that should be highlighted to the patient, etc.

In another embodiment, the large flat portion of the bottle system (e.g. the bottom portion or underside) is further differentiated from other bottle systems by having a large and flat panel that can adhere a pharmacy label (e.g. prescription related information.) This embodiment allows the consumer to read the pharmacy label with greater ease and clarity as the entire label is flat and planar.

In one embodiment, the sides of the pharmacy bottle system contain slight protrusions which generally run along the outer edges (‘sides’) of the container. This embodiment provides the consumer with greater control of the pharmacy bottle system when it is being opening (e.g. affording grip for the hand and/or finger(s)), closed, or during other movements in which the consumer needs additional points of contact to control the bottle system.

In another embodiment, the general design of the pharmacy bottle system allows it be stackable (e.g. stacking one pharmacy bottle atop another pharmacy bottle of similar size and scale.) This embodiment allows two or more bottles to take up less space than traditional bottles of similar size which have been historically cylindrical and round.

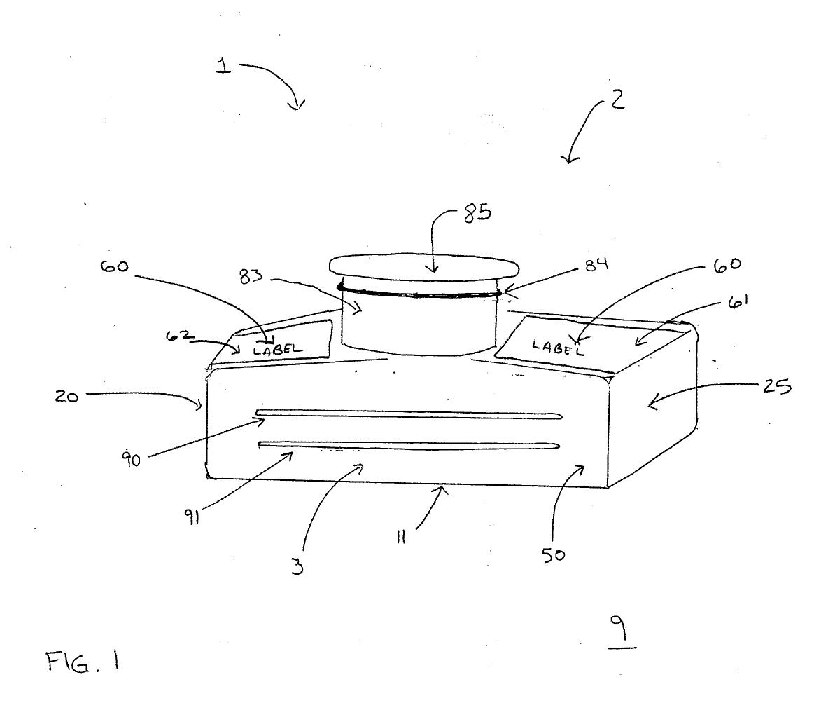

These embodiments and other embodiments of the invention are described and illustrated in greater detail in association with FIGS. 1-5.

As shown in in FIG. 1, in one embodiment, pharmacy bottle system 1 is comprised of a bottle 2 with a cap 85 and collar 84 on each bottle 2. Each bottle 2 comprises a container 3 and a label 61 or series of labels 61 and 62. Container 3 comprises side portion 50, bottom portion 11, top portion 60, leading end portion 20 and a trailing end portion 25.

Container 3 presents a unique combination of different shapes, surfaces, textures and features in one bottle 2. First, bottle 2 lays flat on a support surface 9, such as a countertop, table or shelf by placing surface edge 11 down on the support surface 9 to cause container 3 to extend upwardly from support surface 9. In this orientation, spine portion 83 is considered top of the bottle 2 in conjunction with cap 85 (which covers a mouth of bottle 2) and side 11 is considered bottom of bottle 2. This orientation of bottle 2 maximizes readability of label 62 and label 61 on container 3 and presents new and unique ways of handling a pharmacy bottle 2.

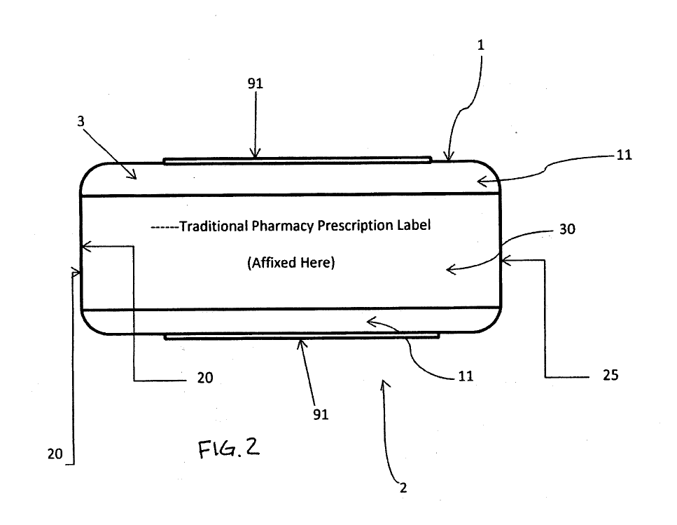

As shown in FIG. 2, label 30 is adhesively secured to container 3 in bottle system 2. Bottle system 2 in container 3 allows for a flat label to be uniformly and directly applied to bottle container 3 without the need to adhere to a traditional curved surface. Such innovation is a marked improvement and measurable improvement over traditional pharmacy bottle systems. Plastic extensions 91 and 90 allow for the user to secure hold, grasp or otherwise handle bottle system 2 with ease to better secure bottle system 2. Label 30 will generally be placed between leading edge 20 and trailing edge 25. Label 30 will generally be placed between plastic edges 91 on each respective side of the bottle system—creating a smooth label along a generally smooth surface of bottom 11.

In one embodiment noted in FIG. 2, bottom portion 11 of container 3 defines a substantially planar surface that is rectangular shaped, thereby defining a generally flat and broad surface especially suited for reading information on label 30. This unique embodiment allows the clear display of information on label 30 to be read without the need for turning or twisting a typical round or cylindrical bottle. This embodiment allows the entire primary pharmacy label to be read with ease.

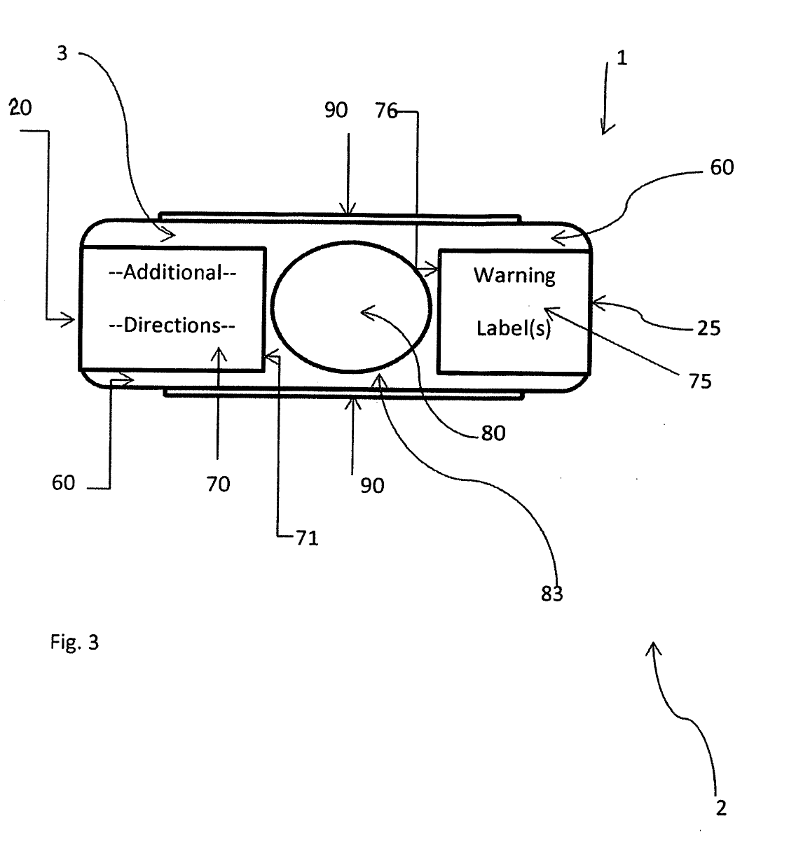

As shown in FIG. 3, label 70 and label 75 are adhesively secured to container 3. Label 70 and label 75 comprise a mechanism to display patient information, including patient name, drug information, retail pharmacy information, etc. which is distributed throughout the top portion 60.

Bottle system 2 comprises multiple distinct profiles, depending on the view taken of bottle system 2, with each profile uniquely enhancing a patient's experience with bottle system 2. In a view in which the consumer directly faces the bottle system 2 with portion 11 flat against table 9 or shelf 9, the cap 85 will be centered between warning messages, additional directions for the patient, information from the pharmacy, the patients name, etc. appearing on adhesive label 70 and adhesive label 75.

Opening bottle 2 also creates a distinct and unique method not similar in scope to traditional cylindrical and round bottle systems. Since one hand can hold the generally rectangular bottle system 1, the other hand can more easily open the cap 85 by either turning cap 85 or by holding cap 85 while simultaneously turning bottle system 1.

Accordingly, the combination of this distinctive design for the consumer coupled with the distinctive design for the pharmacy to attach adhesive labels generally used for patient information, drug information, directives, warning labels, etc. while simultaneously allowing the patient to open and close the bottle system 1 with limited strength and effort, presents a radically different pharmacy bottle.

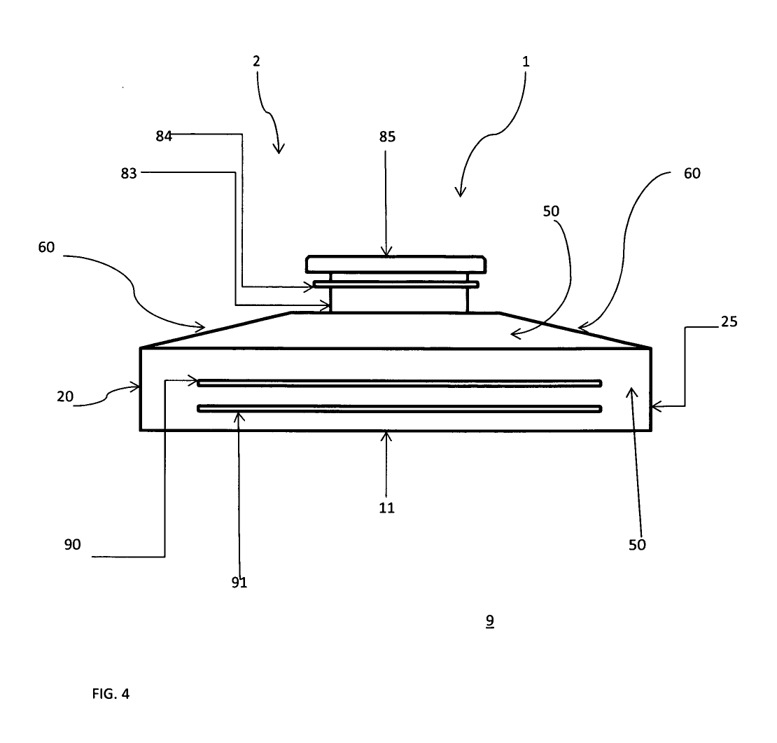

As further shown in FIG. 4, side portion 50 of container 3 is generally of a slight trapezoidal shaped, being interposed between top portion 60 and bottom portion 11. The height of side portion 50 is generally greater as it nears the cylindrical area 83 and smaller as it gets nearer leading end portion 20 and trailing end portion 25.

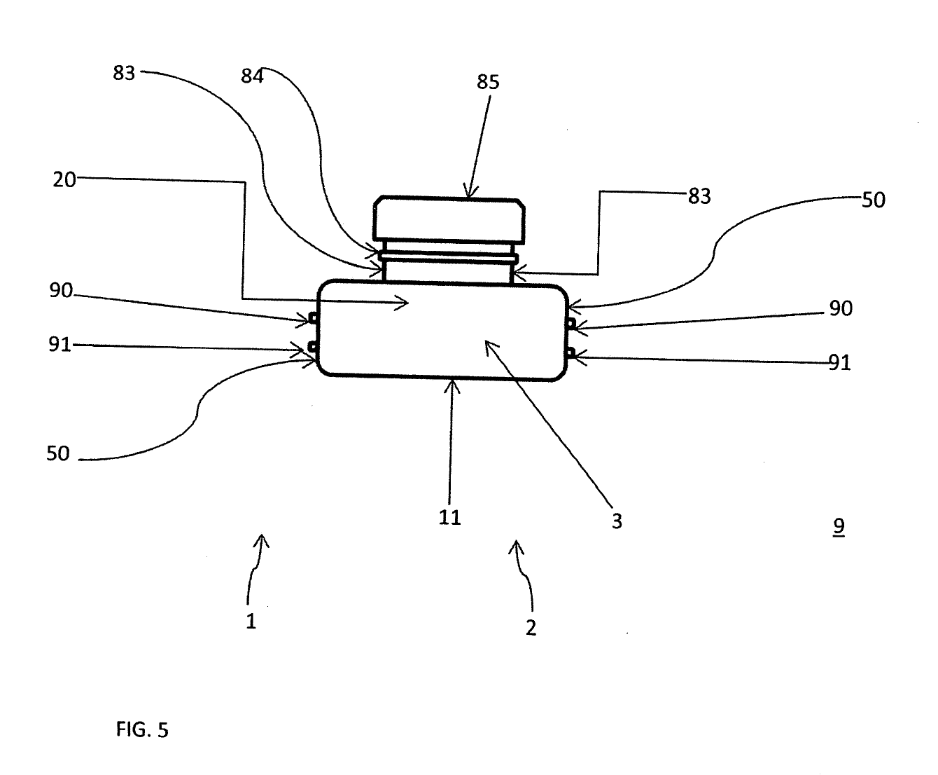

In one embodiment, as shown in FIG. 5, which is of a plan view of the leading end portion 20 including the stem 83 and cap 85, a radically and distinct embodiment is visible in the application of slightly protruding rails delineated as 91 and 90. These two embodiments of 91 and 90 contribute to the patient being able to grip the bottle system more easily than with other bottle systems. Furthermore, FIG. 5 and FIG. 4 and FIG. 3 and FIG. 2 and FIG. 1 further embody the feature of 90 and 91—which generally run along the generally trapezoidal side panels 50 on both equidistant panels 50 which are of generally the same size and shape.

As shown in FIG. 5, the leading edge side 20 is of generally the same size and shape as trailing edge 25. FIG. 5 further demonstrates the generally shape and size of bottle system 3, including the prevailing rails 90 and 91 appearing on both side panel 50 of the bottle system 3—which extend slightly from side panels 50.

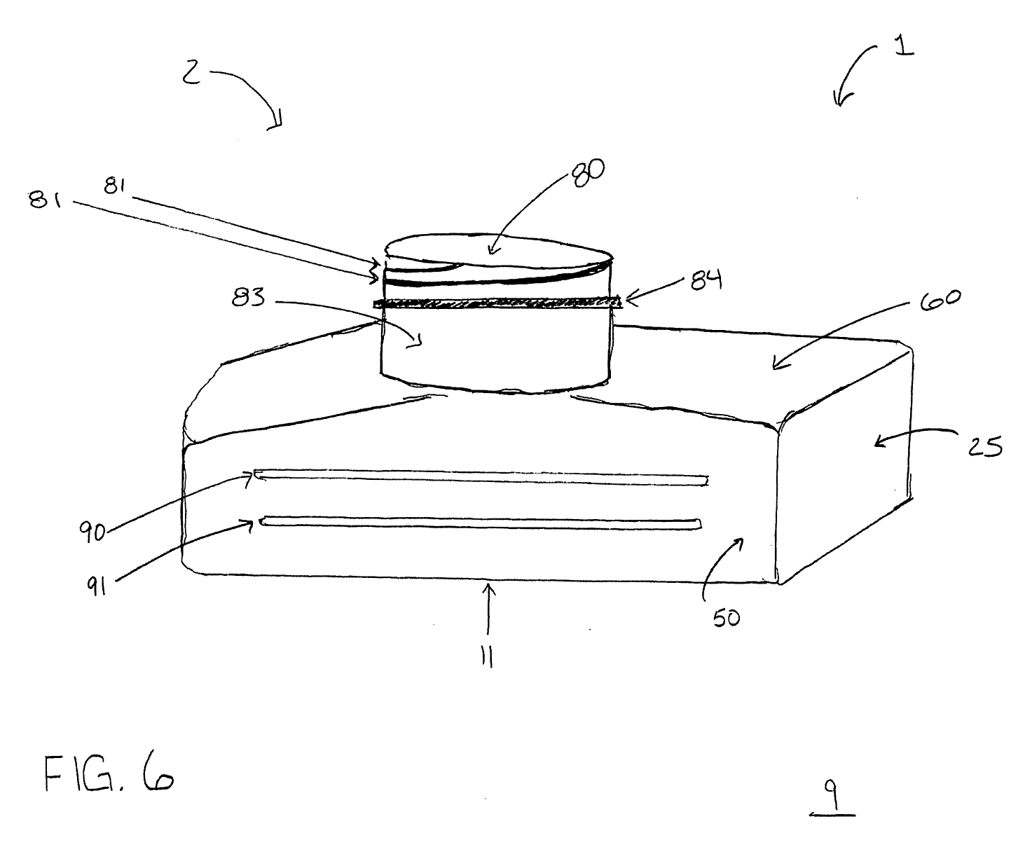

As shown in FIG. 6, the mouth 80 includes opening an elongated stem 83 and threaded design 81 for threadably engaging cap 85 to cover opening 80.

What is claimed is:

1.) A prescription pharmacy bottle comprising:
a container including a top side and a second side opposite the top side, the container comprising:
a generally planar top portion having a generally rectangular shape and extending from the first end of the container to the second end of the container;
a generally planar bottom portion spaced from the generally planar top portion, the generally planar bottom portion having a generally rectangular shape and generally facing away in an opposite direction from the generally planar top portion, the generally planar bottom portion extending from the first end of the container to the second end of the container;
a pair of side portions opposite to and spaced from each other, with each side portion extending between the generally planar top portion of the container, each side portion comprising a generally trapezoidal shape to position the generally planar top portion of the container and the generally planar bottom portion of the container to diverge away from each other at the first end of the container and to converge toward each other at the second end of the container;
an opening at least partially defining the top portion of the container and extending between the generally planar top portion and the generally planar bottom portion of the container, the opening spaced from and opposite to the bottom portion of the container, wherein the opening is adapted to removably receive a cap to cover the opening;
a medication-related label extending over and in contact with the generally planar top portion, the end portions and the generally planar bottom portion;
wherein each respective top portion and bottom portion of the container is configured for adhesive placement of the medication-related label on at least one of the top portion and the bottom portion of the container.

2.) The prescription pharmacy bottle of claim 1 wherein each respective side portion includes a top portion and a bottom portion, the top portion of the respective side portions having a length less than a length of the bottom portion of the respective side portions, the bottom portion of the respective side portions being disposed adjacent the first end of the container.

3.) The prescription pharmacy bottle of claim 1 wherein a size and a shape of the generally planar top portion of the container and a size and a shape of the generally planar bottom portion of the container are generally symmetrical relative to each other and wherein a size and a shape of the respective side portions of the container are generally symmetrical relative to each other.

4.) The prescription pharmacy bottle of claim 1 wherein the generally planar top portion of the container and the generally planar bottom portion of the container have a height that is greater than the opening of the container.

5.) The prescription pharmacy bottle of claim 1 wherein the container comprises:
at least one protrusion disposed on at least one of the respective side portions of the container.

6.) The prescription pharmacy bottle of claim 1 wherein the top portion and the bottom portion of the container each have a width that is greater than the opening of the container.

7.) The prescription pharmacy bottle of claim 6, wherein the container defines a threaded neck at the top portion of the bottle.

8.) The prescription pharmacy bottle of claim 1 wherein the container comprises:
at least one protrusion disposed on at least one of the respective side portions of the container.

9.) The prescription pharmacy bottle of claim 8 wherein the at least one protrusion comprises an array of protrusions.

10.) The prescription pharmacy bottle of claim 9 wherein the at least one protrusion is raised from a surface of the at least one respective side portion and defines a recessed surface within the protrusion.

11.) A prescription pharmacy bottle comprising:
a prescription medication;
a container holding the prescription medication, the container including:
a generally planar top portion having a generally rectangular shape and extending from the first end of the container to the second end of the container,
a generally planar bottom portion spaced from the top portion, the back portion having a generally rectangular shape and generally facing away in an opposite direction from the front portion, the generally planar top portion extending from a front end of the container to the back end of the container,
a pair of side portions opposite to and spaced form each other, with each side portion extending between the generally planar bottom portion of the container, each side portion comprising at least one of a generally rectangular shape and a generally trapezoidal shape positioned such that the generally planar bottom portion and the generally top portion diverge away from each other at the front and back end of the container, and
a label related to the prescription medication adhered to the top portion and the bottom portion of the container.
